(19) United States
(12) Patent Application Publication
(10) Pub. No.: US 2015/0032547 A1
(43) Pub. Date: Jan. 29, 2015

(54) METHODS FOR PROVIDING ADVERTISEMENTS IN A DIGITAL RADIO AND DEVICES THEREOF

(71) Applicant: Wipro Limited, Bangalore (IN)

(72) Inventor: Rani Malhotra, Bangalore (IN)

(73) Assignee: Wipro Limited, Bangalore (IN)

(21) Appl. No.: 13/974,251

(22) Filed: Aug. 23, 2013

(30) Foreign Application Priority Data
Jul. 25, 2013 (IN) 3319/CHE/2013

(51) Int. Cl. G06Q 30/02

(52) U.S. Cl. CPC G06Q 30/0267
USPC 705/14.64

(57) ABSTRACT

A method, non-transitory computer readable medium, and a mobile computing device comprises receiving multiplexed data comprising an audio program and one or more advertisements from a broadcasting computing device, wherein the advertisements are each assigned to one of one or more genres. The received multiplexed data is demultiplexed to separate the audio program and the one or more advertisements. Next, based on program information of the audio program, genre corresponding with the program information of the audio program is identified. Further, one or more of the advertisements associated with the identified one of the genres that corresponds with the program information of the audio program are identified. The audio program and the identified one or more of the advertisements are output.

This application claims the benefit of Indian Patent Application Filing 3319/CHE/2013, filed Jul. 25, 2013, entitled “METHODS FOR PROVIDING ADVERTISEMENT IN A DIGITAL RADIO AND DEVICES THEREOF”, which is hereby incorporated by reference in its entirety.

### FIELD

This technology generally relates to advertising, more particularly, to methods for providing advertisements in a digital radio and devices thereof.

### BACKGROUND

Digital radio broadcasting relates to systems which transmit digitized, compressed analog audio signal using a digital modulation scheme. The use of digital radio is increasing day by day as digital radio provides several advantages over existing analog radio. For example, digital radio enables a higher number of radio programs in a given spectrum, improves the audio quality, eliminates fading problems in mobile environments, allows additional data casting services, and decreases the transmission power or the number of transmitters required to cover a region.

Due to the increased use and reach of digital radio, advertising in a digital radio also has become a new and more important marketing tool for corporations, organizations, and other entities promoting a product or service. Current analog radio advertising technologies are configured to provide advertisements in slots between programs. This limits the number of advertisements which can be provided in these limited windows and these advertisements are restricted to only audio advertisements.

### SUMMARY

A method for providing advertisement in a digital radio includes a mobile computing device receiving multiplexed data comprising an audio program and one or more advertisements from a broadcasting computing device, wherein the advertisements are each assigned to one of one or more genres. The received multiplexed data is demultiplexed by the mobile computing device to separate the audio program and the one or more advertisements. Next, based on program information of the audio program, genre corresponding with the program information of the audio program is identified. by the mobile computing device. Further, one or more of the advertisements associated with the identified one of the genres corresponding with the audio program are identified by the mobile computing device. The audio program and the identified one or more of the advertisements are output by the mobile computing device.

A non-transitory computer readable medium having stored thereon instructions for providing advertisement in a digital radio comprising machine executable code which when executed by at least one processor, causes the processor to perform steps including receiving multiplexed data comprising an audio program and one or more advertisements from a broadcasting computing device, wherein the advertisements are each assigned to one of one or more genres. The received multiplexed data is demultiplexed to separate the audio program and the one or more advertisements. Next, based on program information of the audio program, genre corresponding with the program information of the audio program is identified. Further, one or more of the advertisements associated with the identified one of the genres that corresponds with the program information of the audio program are identified. The audio program and the identified one or more of the advertisements are output.

A mobile computing device comprising one or more processors, a memory, wherein the memory coupled to the one or more processors which are configured to execute programmed instructions stored in the memory including receiving multiplexed data comprising an audio program and one or more advertisements from a broadcasting computing device, wherein the advertisements are each assigned to one of one or more genres. The received multiplexed data is demultiplexed to separate the audio program and the one or more advertisements. Next, based on program information of the audio program, genre corresponding with the program information of the audio program is identified. Further, one or more of the advertisements associated with the identified one of the genres that corresponds with the program information of the audio program are identified. The audio program and the identified one or more of the advertisements are output.

This technology provides a number of advantages including providing more effective methods, non-transitory computer readable medium and devices for advertising with digital radio. With this technology, the volume of advertisements provided to the receiver can be substantially increased thereby helping the corporations, organizations, and other entities to more effectively advertise and generate more revenue. Additionally, by creating and storing an advertisement catalogue at the receiver with this technology, advertisements can be identified and provided even when the receiver is offline or not connected to the internet. Further, by providing advertisements over digital radio with this technology, advertisements can be more easily broadcasted to more locations.

### BRIEF DESCRIPTION OF THE DRAWINGS

FIG. 1 is a block diagram of an exemplary mobile computing device for advertising in a digital radio;

FIG. 2 is an exemplary flowchart for providing advertisement in a digital radio;

FIG. 3 is an exemplary flowchart for advertising in digital radio from a mobile computing device;

FIG. 4 is an exemplary block diagram of an advertisement catalogue;

FIG. 5 is an exemplary block diagram of a digital radio including currently playing audio program and advertisement associated with the genre of the currently playing audio program;

FIG. 6 is an exemplary block diagram of the digital radio including currently playing audio program and updated advertisement associated with the genre of the currently playing audio program; and

FIG. 7 is an exemplary XML code for a genre type of an audio program.

### DETAILED DESCRIPTION

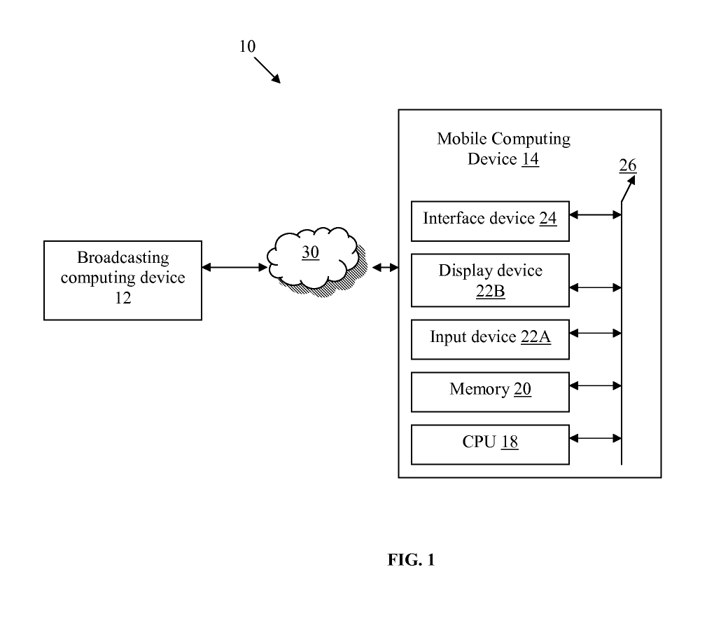

An exemplary environment 10 including a broadcasting computing device 12, and a mobile computing device 14 for providing advertisement in a digital radio is illustrated in FIG. 1. The exemplary environment 10 includes a broadcasting computing device 12, the mobile computing device 14, and which are coupled together by a communication network 30, although the environment can include other types and numbers of devices, components, elements, and communication networks 30 in other topologies and deployments. While not shown, the exemplary environment 10 may include additional components, such as database etc, which are well known to those of ordinary skill in the art and thus will not be described here. This technology provides a number of advantages including providing more effective methods, non-transitory computer readable medium and devices for advertising in a digital radio.

The mobile computing device 14 assists with providing advertisement in a digital radio as illustrated and described with the examples herein, although mobile computing device 14 may perform other types and numbers of functions. The mobile computing device 14 includes at least one CPU/processor 18, memory 20, input device 22A and display device 22B, and interface device 24, which are all coupled together by bus 26, although mobile computing device 14 may comprise other types and numbers of elements such as an antenna for receiving analog or digital signals in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

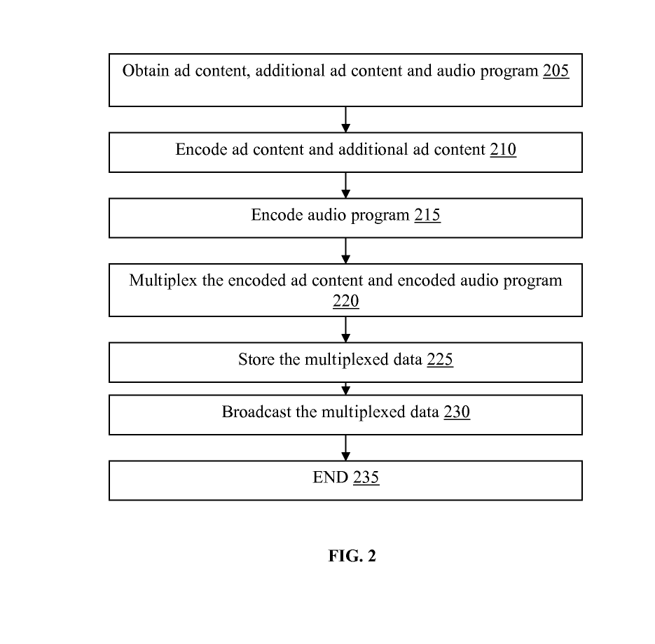

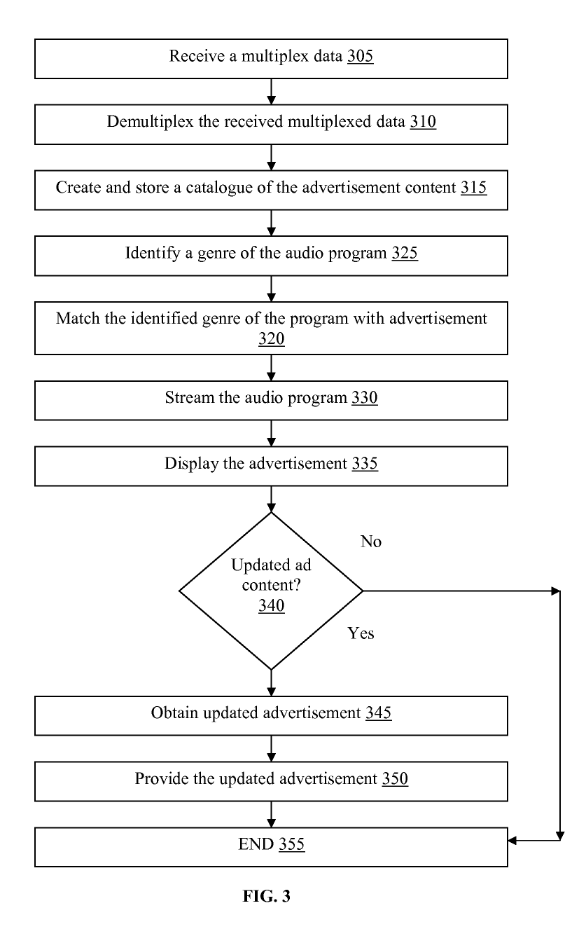

Memory 20 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIGS. 2-3 is representative of example steps or actions of this technology that may be embodied or expressed as one or more non-transitory computer or machine readable instructions stored in memory 20 that may be executed by the processor(s) 18.

Input device 22A enables a user, such as a programmer or a developer, to interact with the mobile computing device 14, such as to input and/or view data and/or to configure, program and/or operate it by way of example only. By way of example only, input device 22A may include one or more of a touch screen, keyboard and/or a computer mouse.

The display device 22B enables a user, such as an administrator, to interact with the mobile computing device 14, such as to view and/or input information and/or to configure, program and/or operate it by way of example only. By way of example only, the display device 22B may include one or more of a CRT, LED monitor, LCD monitor, or touch screen display technology although other types and numbers of display devices could be used.

The interface device 24 in the mobile computing device 14 is used to operatively couple and communicate between the mobile computing device 14 and broadcasting computing devices 12, although other types and numbers of systems, devices, components, elements and/or networks with other types and numbers of connections and configurations can be used. By way of example only, the mobile computing device 14 can interact with other devices via a communication network 30 such as Local Area Network (LAN), analog radio signals, digital radio signals and Wide Area Network (WAN) and can use TCP/IP over Ethernet and industry-standard protocols, including NFS, CIFS, SOAP, XML, LDAP, and SNMP, although other types and numbers of communication networks, can be used. Additionally, in this example, the broadcasting computing device 12 uses protocol DAB-MOT (EN 301 234 [3]) to transmit the advertisement and audio files to the mobile computing device 14 and working, specification and formats associated with DAB-MOT (EN 301 234 [3]) is incorporated here in its entirety. In this example, the bus 26 is a hyper-transport bus in this example, although other types of buses and/or other links may be used, such as PCI.

Each of the broadcasting computing devices 12 includes a central processing unit (CPU) or processor, a memory, an interface device, input device and display device, which are coupled together by a bus or other link, although each could have other types and numbers of elements and/or other types and numbers of network devices could be used in this environment. The broadcasting computing device 12, in this example, may run applications to broadcast advertisements and audio program to mobile computing device 14, although the broadcasting computing device 12 can broadcast the advertisements and audio program to other devices.

It is to be understood that the methods of the examples described herein are for exemplary purposes, as many variations of the specific hardware and software used to implement the examples are possible, as will be appreciated by those skilled in the relevant art(s).

Furthermore, each of the methods of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as the non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

An exemplary method for providing advertisement in a digital radio will now be described with reference to FIGS. 1-7. Referring more specifically, to FIG. 2, an exemplary process for Referring more specifically, to FIG. 2, an exemplary process for providing advertisement in a digital radio will now be described.

At step 205, the broadcasting computing device 12 obtains advertisement content, audio program and other information associated with the advertisement content from an advertisement and audio content database (not shown), although the broadcasting computing device 12 may obtain the advertisement content, program content and other information associated with the advertisement content from other locations. In this example, the audio program relates to audio files containing information, such as news, science and technology which has to be broadcasted, although the program content can include types of information.

Next, in this example, the advertisement content relates to images of advertisements in jpeg or gif formats, although the advertisement content can be of different types, such as audio files, video files, or text files by way of example only and in a variety of different formats. The other information associated with the advertisement content can include a unique identification number of the advertisement and the location from which the advertisement was obtained from, although the other types and amounts of information can be associated with the advertisement. Additionally, in this example the advertisement content once obtained is grouped together by the broadcasting computing device 12 based on the genre of advertising content in the advertisement. For example, the advertising content in each of the advertisements may be associated with a genre, such as science and technology, music or sports, and then grouped together based on that genre.

Next, in step 210, the broadcasting computing device 12 encodes the obtained advertisement content and the other information associated with the advertisement content into multimedia object transfer (MOT) object(s). In this example, obtained advertisement content is encoded into an object body in the packet data format of the DAB-MOT (EN 301 234 [3]), although the advertisement content and other information associated with the advertisement can be encoded in other formats suitable for broadcasting using DAB-MOT (EN 301 234 [3]) protocol, such as XPAD format. Additionally, in this step, the broadcasting computing device 12 groups the obtained advertisement content based on genre to form a multimedia object transfer (MOT) directory, although the broadcasting computing device 12 can group the obtained advertisement content based on other parameters.

In step 215, the broadcasting computing device 12 encodes the audio program in MPEG-2 or AAC format and places the encoded audio program into the object body of the packet data format of the DAB-MOT (EN 301 234 [3]), although the audio program can be encoded in other formats suitable for broadcasting using DAB-MOT (EN 301 234 [3]).

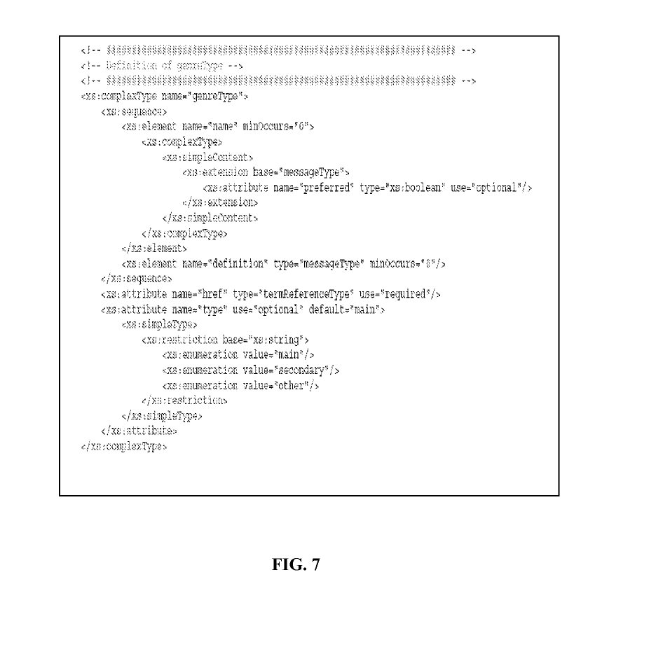

Additionally, in this example, the broadcasting computing device 12 includes the program information associated with the audio program such as genre of the current audio program, genre of the next audio program, keywords relating to the audio program, or schedule information in a data format such as XML code, in accordance with protocol format ETS TS 102 818, whose working and specification is incorporated herein entirety, although the broadcasting computing device 12 can include other types of information associated with the audio program in another formats. By way of example only, the XML code for genre type of the audio program is illustrated in FIG. 7. As it would be appreciated by a person having ordinary skill in the art, ETS TS 102 818 include technical specifications for digital audio broadcasting (DAB) and electronic program guide (EPG).

In step 220, the broadcasting computing device 12 multiplexes the encoded advertisement, other information associated with advertisement and the audio program using the multiplexing format suitable for DAB-MOT (EN 301 234 [3]) protocol. By way of example only, the broadcasting computing device 12 places the encoded audio program in an audio data stream and the encoded advertisement content in an image data stream of the DAB-MOT (EN 301 234 [3]) protocol. The broadcasting computing device 12 then multiplexes the two data streams together to form one multimedia packet stream which would be ready for broadcasting.

Next, in step 225, the broadcasting computing device 12 stores the multiplex data within the memory of the broadcasting computing device 12, although the broadcasting computing device 12 can store the multiplexed data at other memory locations.

In step 230, the broadcasting computing device 12 broadcasts the stored multiplexed data via the communication network 30 to receiving devices, such as mobile computing device 14, although the multiplexed data can be provided in other manners. In this example, by broadcasting the stored multiplexed data, the broadcasting computing device 12 transmits the MOT directory, which includes grouped advertisements and the encoded audio program to receiving devices, such as the mobile computing device 14. Additionally, in this example the broadcasting computing device broadcasts the program information associated with the audio program such as genre of the current audio program, genre of the next audio program, keywords relating to the audio program, or schedule information via communication network 30 to the receiving devices, such as mobile computing device 14, although the information associated with the audio program can be provided to the receiving devices in other manners.

Referring now to FIG. 3, an exemplary process of providing advertisements in a digital radio on the mobile computing device 14 will now be described. At step 305 where the mobile computing device 14 receives the multiplexed data broadcasted by the broadcasting computing device 12, although the mobile computing device 14 can receive the multiplex data from other devices. In this example, the multiplexed data includes one or more advertisements grouped based on the genre and an audio program, although the multiplexed data can include other types of information. Additionally, in this example, the genre of the program information of the audio program is news, although the program information of the audio program can include other types of genre such as science and technology, music or sports. Also in this example, the program information of the audio program includes an audio file relating to news, although the audio program can also include audio files relating to other genres, such as science and technology, music or sports.

In step 310, the mobile computing device 14 demultiplexes the received multiplexed data to separate out the audio program and the grouped advertisements, although the mobile computing device 14 can perform other types of functions on the received multiplexed data. By way of example only, the mobile computing device 14 separates out the audio program and the grouped advertisements based on the extension of the audio program and the grouped advertisements, although the mobile computing device 14 can use other methods or techniques to separate the audio program and the grouped advertisement content. The grouped advertisements in each genre referred to in the examples illustrated and described herein can each comprise one advertisement or multiples advertisements. In this example, the mobile computing device 14 separates the advertisements associated with news, science and technology, music or sports and program information comprising audio programs relating to news, science and technology, music or sports.

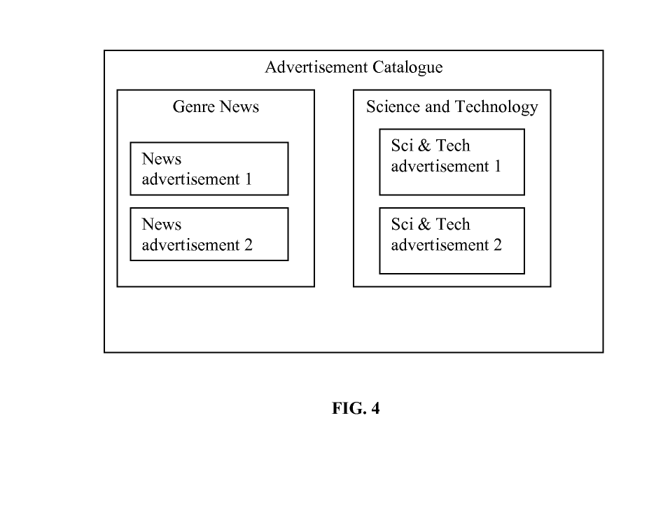

In step 315, the mobile computing device 14 creates an advertisement catalogue of the received grouped advertisements as illustrated in FIG. 4. In this example, the mobile computing device 14 arranges the grouped advertisement (which is in form of MOT directory) in the advertisement catalogue based on the associated genre for the grouped advertisements which in this example are news, science and technology, music or sports, although the mobile computing device 14 can arrange the grouped advertisement in other manners and parameters, such as based on the country of origin of the advertisements or based on designated favorite or preferred advertisements. Additionally, the mobile computing device 14 stores the created advertisement catalogue in memory 20 of the mobile computing device 14, although the mobile computing device 14 can store the created catalogue at other memory locations. By creating and storing the advertisement catalogue, this technology can provide advertisements even when a connection for the digital radio signal is lost or off.

In step 320, the mobile computing device 14 identifies a genre of the audio program based on the program information associated with the audio program which is broadcasted by the broadcasting computing device 12 in step 215, although the mobile computing device 14 can identify the genre of the audio program using other techniques. By way of example only, the program information includes a keyword which in this example is news in the information associated with the audio program previously illustrated, describing the genre of the audio program and the mobile computing device 14 identifies the genre of the audio program based on the keyword, although the mobile computing device 14 can identify the genre using other techniques or using other information present in the program information. Accordingly, in this example, the genre of the current audio program is news, where news is one of many possible genres.

Optionally, the mobile computing device 14 can also identify another genre of the next audio program based on the program information associated with the audio program which includes the genre of the next audio program which will be broadcasted, although the mobile computing device 14 can identify the genre of next program information using other techniques. In this example, science and technology is the genre of the next audio program, which is again one of many possible genres.

Next, in step 325 the mobile computing device 14 identifies the group of advertisements, which can comprise one or multiple advertisements, in the same genre as the identified genre of the audio program from the store advertisement catalogue, although the mobile computing device 14 can identify the group of advertisements in other manners and from other locations. In this example, the mobile computing device 14 matches the identified genre of the audio program with the advertisements stored in the advertisement catalogue under the same genre, although the mobile computing device 14 can use other techniques to determine the group of advertisements associated with the genre of the audio program. By way of example only, the group of advertisements associated with the genre news is news advertisement 1 and news advertisement 2 as illustrated in FIG. 4.

Optionally, in this example, the mobile computing device 14 can also identify the group of advertisements in a genre which matches the genre of the program information of the next audio program to be output, although the mobile computing device 14 can identify the next group of advertisements to be output in other manners. In this example, the genre of the program information of the next audio program to be output is science and technology so the next group of advertisements identified as a match could be, Sci & Tech advertisement 1 and Sci & Tech advertisement 2 as illustrated in FIG. 4.

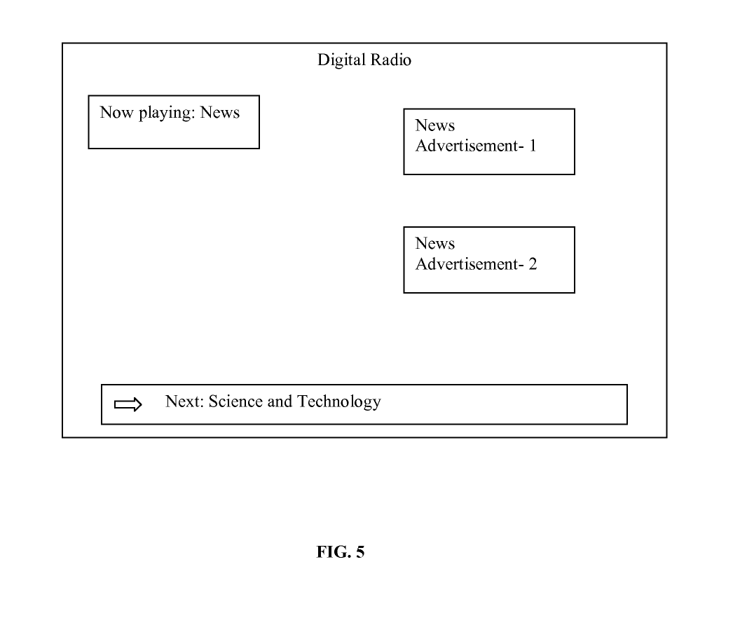

Upon identifying the group of advertisements which matches the genre of the program information in the current audio program being output, then in step 330 the mobile computing device 14 begins to output the audio program by streaming the audio program, although the mobile computing device 14 can begin to output the audio file in parallel while determining the group of advertisements in a genre which matches the genre of the program information in the current audio program. In this example, the mobile computing device 14 outputs the current audio program which is in the genre of news as illustrated in FIG. 5.

Next in step 335, the mobile computing device 14 outputs the determined advertisement(s) from the identified group of advertisements which match the genre of the program information of the audio program currently streaming. In this example, the mobile computing device 14 displays a group of advertisements in the genre of news which matches the genre of news for the program information of the audio program being output as illustrated in FIG. 5.

Alternatively, the mobile computing device 14 also can display the entire advertisement catalogue which was created and stored in step 315 on the display device 22B to the user of the mobile computing device 14 so that the user can review, select, and view one or more of the advertisements in one or more of the groups of advertisements. By way of example only, the mobile computing device 14 displays a catalogue icon on the display device 22B and when activated displays the entire advertisement catalogue, although the mobile computing device 14 can display the entire advertisement catalogue using other techniques. Additionally by providing the advertisement catalogue, this technology enables the user of the mobile computing device 14 to save an advertisement for future viewing or even share an advertisement while viewing the entire advertisement catalogue. By way of example only, the mobile computing device 14 provides save and share icon while displaying each advertisement in the advertisement catalogue, although the mobile computing device 14 can provide other types of icons such as add to favorite. Accordingly, while viewing the entire advertisement catalogue displayed on the display device 22B, the user of the mobile computing device can either select the save icon and that particular saved advertisement is stored separately within the memory 20 of the mobile computing device 14 so that the user can either look at only the saved advertisement at a later time or use it for other purposes. Similarly, if the user of the mobile computing device 14 selects the share icon for a particular advertisement while viewing the entire advertisement catalogue, the mobile computing device 14 assists the user with sharing of the advertisement via email, text message or multimedia message.

Additionally in this example, if the user of the mobile computing device 14 selects one of many displayed advertisements in the entire advertisement catalogue and adds to favorite by selecting the add to favorite icon displayed, the mobile computing device 14 creates and stores a separate catalogue within the memory 20 which includes only the favorite advertisements so that the user of the mobile computing device 14 can view only the favorite advertisements at a later point of time.

Additionally, in this example, if the mobile computing device 14 determines a group of advertisements that matches the genre of the program information of the audio program currently being output, then the mobile computing device 14 may select the order to display the one or more advertisements in the group of advertisements based on one or more parameters such as, number of times the advertisement has been displayed, revenue generated for the broadcaster when a user of the mobile computing device 14 selects a particular advertisement or keyword present in the advertisement which matches the genre of the audio program, although the mobile computing device 14 can use other parameters to determine the sequence of displaying the group of advertisements. By way of example only, if the mobile computing device 14 determines two advertisements matching the same genre and if the first advertisement has been displayed already, then the mobile computing device 14 may select the second advertisement to be displayed and then the first advertisement. Additionally, if the mobile computing device 14 determines that both the first and the second advertisement have been displayed equal number of times, then the mobile computing device 14 may select the order to display the advertisements based on another criteria such as the revenue generated for the broadcaster when a user of the mobile computing device 14 selects a particular advertisement or keyword present in the advertisement which matches the genre of the audio program.

Optionally, the mobile computing device 14 may change the advertisements based on a pre-determined time thereby allowing a large number advertisements to be displayed within program duration. By way of example only, if the duration of the audio program is 30 minutes and if the mobile computing device 14 has determined about 30 different advertisements that matches with the genre of the audio program, the mobile computing device 14 can change each advertisement after 1 minute, so that the user of the mobile computing device 14 can view at least 30 advertisements in the duration of the audio program thereby allowing a large number of advertisements to be displayed within the program duration.

In step 340, the mobile computing device 14 determines if there are one or more updated versions for the previously identified one or more of the advertisements associated with the identified one of the genres that corresponds with the program information of the audio program stored in the broadcasting computing device 12, although the mobile computing device 14 can determine the presence of an updated version of the one or more advertisements at other locations. If the mobile computing device 14 determines that one or more updated versions of the previously identified one or more advertisements is not present in the broadcasting computing device, a No branch is taken to step 355 where the exemplary process ends. However, if the mobile computing device 14 determines that there one or more updated version of the previously identified one or more advertisements present in the broadcasting computing device, then a Yes branch is taken to step 345. In this example, the mobile computing device 14 determines that there are updated advertisements associated with genre News and proceeds to step 345.

In step 345, the mobile computing device 14 obtains the one or more updated advertisements in the genre which matches the genre of the program information of the audio program being output. In this example, the mobile computing device 14 obtains one or more updated advertisements associated with the genre news which are New News Advertisement 1 and New News Advertisement 2.

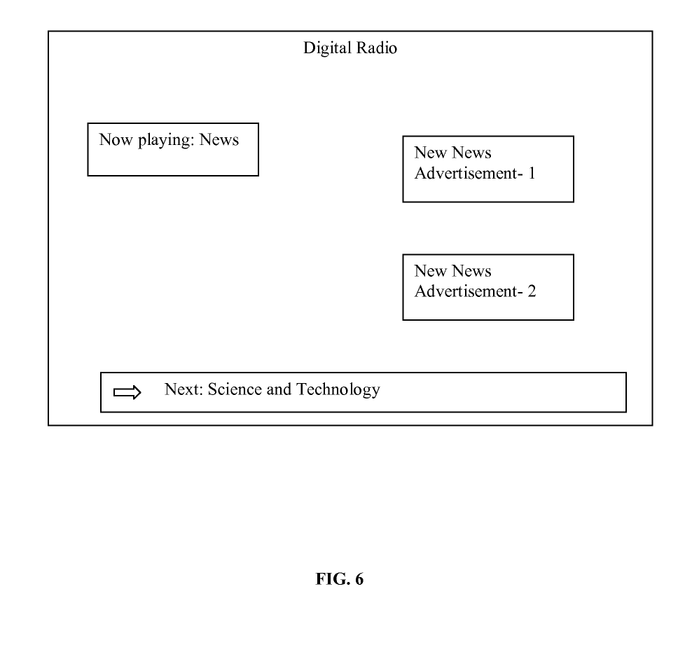

In step 350, the mobile computing device 14 displays the one or more updated advertisements in the genre which matches the genre of the program information in the audio program being output and the exemplary process ends in step 355. In this example, the mobile computing device 14 displays the one or more updated advertisements associated with the genre of news as illustrated in FIG. 6. Optionally, the mobile computing device can also update the previously stored advertisement catalogue with the corresponding one or more updated advertisements.

With this technology, the volume of advertisements provided to the receiver can be substantially increased thereby helping the corporations, organizations, and other entities to more effectively advertise and generate more revenue. Additionally, by creating and storing an advertisement catalogue at the receiver with this technology, advertisements can be identified and provided even when the receiver is offline or not connected to the internet. Further, by providing advertisements over digital radio with this technology, advertisements can be more easily broadcasted to more locations.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing advertisements in digital radio, the method comprising:
receiving by a mobile computing device multiplexed data comprising an audio program and one or more advertisements from a broadcasting computing device, wherein the advertisements are each assigned to one of one or more genres;
demultiplexing by the mobile computing device the received multiplexed data to separate the audio program and the one or more advertisements;
identifying by the mobile computing device based on program information of the audio program, which one of the one or more genres corresponds with the program information of the audio program;
identifying by the mobile computing device one or more of the advertisements associated with the identified one of the genres that corresponds with the program information of the audio program; and
outputting by the mobile computing device the audio program and the identified one or more of the advertisements.

2. The method as set forth in claim 1 further comprising creating by the mobile computing device an advertisement database of the advertisements, wherein the advertisements are arranged in the advertisement database based on the assigned one of the one or more genres for each of the advertisements.

3. The method as set forth in claim 2 further comprising storing by the mobile computing device the created advertisement database within a memory of the mobile computing device.

4. The method as set forth in claim 1 wherein the outputting further comprises displaying by the mobile computing device the at least one of the identified one or more advertisements while outputting the audio program.

5. The method as set forth in claim 4 wherein the displaying further comprises prioritizing by the mobile computing device an order of displaying the identified advertisements based on one or more of a cost per click, historical information, or keyword matching.

6. The method as set forth in claim 1 further comprising:
determining by the mobile computing device availability of one or more updates for the received one or more advertisements associated with the identified one of the genres corresponding with the audio program in the broadcasting computing device;
obtaining by the mobile computing device the one or more updates for the received one or more advertisements when determined to be available; and
outputting by the mobile computing device the one or more updates for the received one or more advertisements associated with the identified one of the genres corresponding with the audio program, while outputting the audio program.

7. A non-transitory computer readable medium having stored thereon instructions for providing advertisements in digital radio comprising machine executable code which when executed by at least one processor, causes the processor to perform steps comprising:
receiving multiplexed data comprising an audio program and one or more advertisements from a broadcasting computing device, wherein the advertisements are each assigned to one of one or more genres;
demultiplexing the received multiplexed data to separate the audio program and the one or more advertisements;
identifying based on program information present of the audio program, which one of the one or more genres corresponds with the program information of the audio program;
identifying one or more of the advertisements associated with the identified one of the genres that corresponds with the program information of the audio program; and
outputting the audio program and the identified one or more of the advertisements.

8. The medium as set forth in claim 7 further comprising creating an advertisement database of the advertisements, wherein the advertisements are arranged in the advertisement database based on the assigned one of the one or more genres for each of the advertisements.

9. The medium as set forth in claim 8 further comprising storing the created database within a memory of the mobile computing device.

10. The medium as set forth in claim 7 wherein the outputting further comprises displaying the at least one of the identified one or more advertisements while outputting the audio program.

11. The medium as set forth in claim 10 wherein the displaying further comprises prioritizing an order of displaying the identified advertisements based on one or more of: a cost per click, historical information, or keyword matching.

12. The medium as set forth in claim 7 further comprising:
determining availability of one or more updates for the received one or more advertisements associated with the identified one of the genres corresponding with the audio program in the broadcasting computing device;
obtaining the one or more updates for the received one or more advertisements when determined to be available; and
outputting the one or more updates for the received one or more advertisements associated with the identified one of the genres corresponding with the audio program, while outputting the audio program.

13. A mobile computing device comprising:
one or more processors;
a memory, wherein the memory coupled to the one or more processors which are configured to execute programmed instructions stored in the memory comprising:
receiving multiplexed data comprising an audio program and one or more advertisements from a broadcasting computing device, wherein the advertisements are each assigned to one of one or more genres;
demultiplexing the received multiplexed data to separate the audio program and the one or more advertisements;
identifying based on program information present of the audio program, which one of the one or more genres corresponds with the program information of the audio program;
identifying one or more of the advertisements associated with the identified one of the genres that corresponds with the program information of the audio program; and
outputting the audio program and the identified one or more of the advertisements.

14. The device as set forth in claim 13 wherein the one or more processors is further configured to execute programmed instructions stored in the memory further comprising creating an advertisement database of the advertisements, wherein the advertisements are arranged in the advertisement database based on the assigned one of the one or more genres for each of the advertisements.

15. The device as set forth in claim 14 wherein the one or more processors is further configured to execute programmed instructions stored in the memory further comprising storing the created database within a memory of the mobile computing device.

16. The device as set forth in claim 13 wherein the one or more processors is further configured to execute programmed instructions stored in the memory for the outputting further comprises displaying the at least one of the identified one or more advertisements while outputting the audio program.

17. The device as set forth in claim 16 wherein the one or more processors is further configured to execute programmed instructions stored in the memory for the displaying further comprises prioritizing an order of displaying the identified advertisements based on one or more of: a cost per click, historical information, or keyword matching.

18. The device as set forth in claim 13 wherein the one or more processors is further configured to execute programmed instructions stored in the memory further comprising:
determining availability of one or more updates for the received one or more advertisements associated with the identified one of the genres corresponding with the audio program in the broadcasting computing device;
obtaining the one or more updates for the received one or more advertisements when determined to be available; and
outputting the one or more updates for the received one or more advertisements associated with the identified one of the genres corresponding with the audio program, while outputting the audio program.
